(19) United States
(12) Patent Application Publication
(10) Pub. No.: US 2008/0014371 A1
(43) Pub. Date: Jan. 17, 2008

(54) Method of Producing a Coated Fishing Hook

(76) Inventors: Mike Mattlage, West, TX (US); Chris Coody, Crawford, TX (US)

Correspondence Address: AARON M. WILKERSON, 5400 BOSQUE BLVD., SUITE 301, WACO, TX, 76710, US

(21) Appl. No.: 11/689,889

(22) Filed: Mar. 22, 2007

Related U.S. Application Data
(62) Division of application No. 10/733,897, filed on Dec. 10, 2003.
Application No. 10/733,897 is a continuation-in-part of application No. 10/461,932, filed on Jun. 13, 2003.

(51) Int. Cl. B05D 1/00; H05H 1/48

(52) U.S. Cl. 427/576

(57) ABSTRACT

An improved fishing hook and method of coating the fishing hook with Titanium or a Titanium alloy is provided.

### CROSS REFERENCE TO RELATED APPLICATIONS

This application is a divisional application of U.S. patent application Ser. No. 10/733,897 filed on Dec. 10, 2003, which is a continuation-in-part of U.S. patent application Ser. No. 10/461,932, filed Oct. 14, 2004.

### BACKGROUND

The invention relates to an improved wear-resistant composition of materials used for fishing hook construction.

Conventional fishing hooks are made of one form or another of metal. However, the present materials (stainless steel probably representing the best performing material) are not optimal, at least when compared to the fishing hook of the present invention, as will be disclosed hereafter.

Presently available fishing hooks deteriorate (especially when used in salt water environments, although such does occur in all contexts) and fail to retain the sharpness of their tips and barbs.

Heat-treating a fishing hook to form hard penetrating surfaces will still produce a hook which will dull very quickly. This, in turn, reduces the frequency of successful catches.

Objects of the invention include an improved fishing hook exhibiting at least penetrating and barb surfaces and tips which are of high hardness, exhibit low coefficient of friction and extended service life, and which are economically feasible for commercial production.

### SUMMARY

The present invention provides a wear-resistant fishing hook constructed of, or coated with titanium or an alloy thereof.

### BRIEF DESCRIPTION OF THE DRAWINGS

These and other features, aspects, and advantages of the present invention will become better understood with regard to the following description, appended claims, and accompanying drawings where:

FIG. 1 is a side view of an electric arc physical vapor deposition apparatus used to coat a fishing hook;

FIG. 2 is a diagrammic illustration of the deposition of the evaporated cathode material;

FIGS. 2A-2C are alternative geometrical representations of the solid cathode surrounded by substantially conforming alternative geometrical representations of hollow elongated members.

### DETAILED DESCRIPTION OF THE PREFERRED EMBODIMENT

The improved fishing hook of the present invention can be produced in a variety of ways. In the interest of providing an enabling disclosure, several approaches (not exhaustive) are provided below.

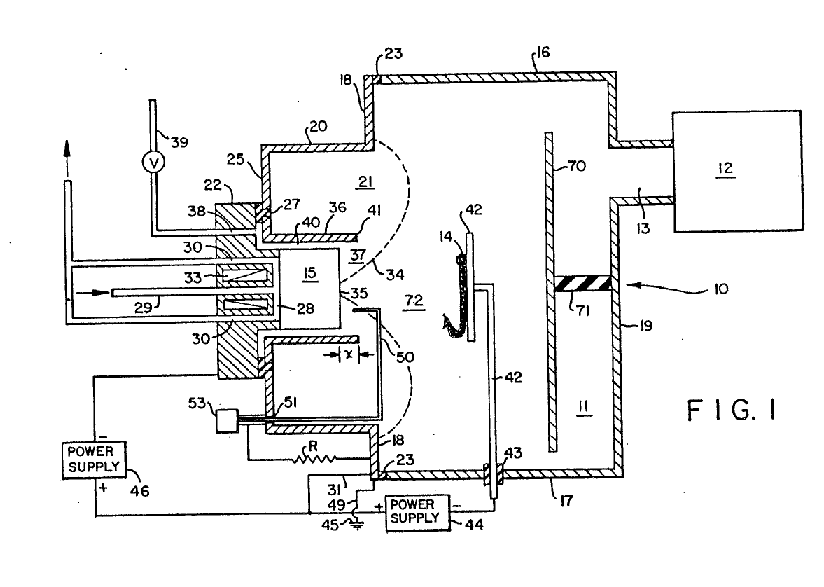

Referring now to FIG. 1, in which the electric arc physical vapor deposition apparatus is used to coat a fishing hook 14, a shell 10 having a vacuum chamber 11 which is evacuated to a desired operating pressure of generally between 10.sup.−1 to 5.times.10.sup.−4 torr and preferably between 5.times.10.sup.−2 and 5.times. 10.sup.−3 torr by a conventional vacuum pumping system 12 communicating with the vacuum chamber 11 through an open port 13.

The vacuum chamber 11 may have any desired geometry and be of any desired size to accommodate one or more fishing hook 14 (substrates) to be coated with source material provided by evaporating one or more solid cathodes 15 in accordance with the practice of the present invention. For illustrative purposes, the shell 10 is shown having a generally rectangular body which, in cross-section, has an upper wall 16, a lower wall 17, and side walls 18 and 19, respectively. The shell 10 further can include an additional section 20 which projects an arbitrary distance from the side wall 18. The side wall 18 has an opening 21 through which the cathode 15 communicates with the vacuum chamber 11.

The cathode 15 is attached to a cathode support assembly 22. The cathode support assembly 22 is mounted on a flange 25 through an insulator 27. The mounting flange 25 is connected to section 20 of the shell 10. The support block 22 has a relatively small cavity 28 which connects with an inlet passage 29 and exit passages 30. A coolant such as water is circulated through the cavity 28 from a source (not shown). The coolant flows from the source through inlet conduit 29 into the cavity 28 and returns to the source through the exit passages 30. A DC magnet 33 is disposed within the support block 22 and serves to diffuse the point of attachment of an electric arc 34 over the arc evaporation surface 35 of the cathode 15.

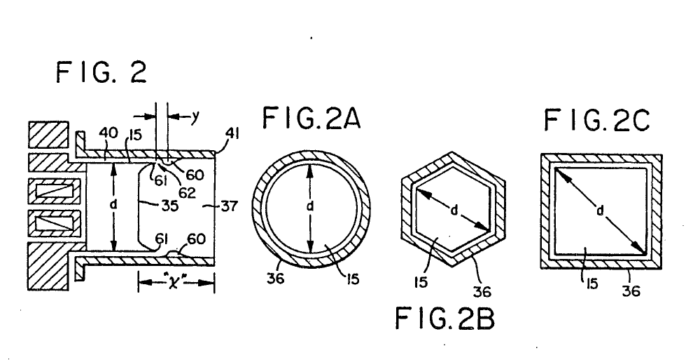

A hollow elongated member 36 surrounds the cathode 15 to form a relatively narrow space 40. The elongated member 36 is attached to the mounting flange 25 through the insulator 27. The geometry of the member 36 and open end 41 should substantially conform to the geometry and dimension of the cathode 15 as shown in FIGS. 2A, 2B and 2C, respectively. The elongated member 36 should be substantially uniform in cross-sectional dimension over its length. This assures that the open end 41 does not restrict the plasma flow as it exits member 36. Accordingly, if a cylindrical or disk shaped cathode is used, the member 36 should preferably be tubular in shape with the narrow space 40 being annular in cross-section. For a 6.35 cm diameter cathode the thickness of the annular space 40 can range from about 0.08 cm to about 0.24 cm. An inlet opening 38 in the support block 22 directly communicates with the narrow space 40 and with an input gas supply line 39. Gas is fed through the gas supply line 39 from a source of gas (not shown) into the narrow space 40 from whence the gas is directed through the cathode chamber 37 into the vacuum chamber 11. A valve V is used to control the flow of gas through the supply line 39.

The elongated member 36 projects a predetermined distance “x” beyond the cathode evaporable end surface 35 to form a cathode chamber 37. The extension “x” between the open end 41 of the member 36 and the evaporable end surface 35 must be above zero and up to a maximum of, for example, about 13 cm in length for a 6.35 cm diameter cathode. The distance “x” is measured from the cathode evaporable end surface 35 as shown in FIG. 2 to the open end 41 of the elongated member 36. The preferred minimum distance “x” is at least about one centimeter and the preferred range for “x” is between 2 to 6 cm for a 6.35 cm diameter cathode. Similar aspect ratios of “x”, herein defined as x/d where “d” is the major dimension of the cathode evaporable end surface 35, must be maintained for all cathode geometries such as those shown in FIGS. 2A, 2B and 2C, respectively. The aspect ratio must be above zero and up to a maximum of about 2.0. The preferred minimum aspect ratio is at least about 0.07 and the preferred range of the aspect ratio is between 0.3 and 1.0. The critical requirement and importance of recessing the cathode within the member 36 to form a cathode chamber 37 will be discussed at greater length later in the specification. The elongated member 36 may preferably be composed of any material that does not interfere with the function of magnet 33 in diffusing the attachment of electric arc 34 over the arc evaporation surface 35 and can comprise any non-magnetic material suitable for high temperature vacuum service, e.g., nonmagnetic stainless steel.

The fishing hook 14 is mounted upon a support plate 42 located within the vacuum chamber 11 and spaced apart from the evaporable end surface 35 of the cathode 15. The type of structure used to support or suspend the fishing hook 14 within the vacuum chamber 11 depends upon the size, configuration and weight of the object. For simplicity, the fishing hook 14 is shown having a rectangular geometry with a flat surface facing the cathode evaporation end surface 35. It should be understood that the fishing hook 14 may have any configuration and may be supported in any fashion. The fishing hook 14 may also be of any suitable composition capable of withstanding the high temperature, vacuum conditions existing in the chamber 11 and can be made of such materials as refractory metal, refractory alloy, superalloy, stainless steel, and ceramic composites. The support plate 42 should, however, be composed of a conductive material and is connected to a metal rod 42 which extends through an insulated high voltage feed-through port 43 in the lower wall 17 of the shell 10. The metal rod 42 is connected to the negative terminal of a bias power supply 44 located external of the shell 10 with the positive terminal of the bias power supply 44 connected to side wall 18 through electrical lead 31.

The vacuum chamber 11 further can include an electrically insulated surface 70 located opposite the cathode evaporable end surface 35 with the fishing hook 14 and support plate 42 positioned therebetween. The electrically insulated surface 70 can be itself comprised of an insulator material or can be comprised of a conductive material which is insulated from the chamber 10 by insulator 71 shown. This electrically insulated surface 70 serves to substantially confine the plasma to the chamber volume 72 between surface 70 and cathode evaporable end surface 35 wherein the fishing hook 14 is located without surface 70 attracting ions or electrons from the plasma and further series to prevent interaction between plasmas when multiple evaporators are accommodated in chamber 11.

Arc current is supplied from a main power supply 46 located external of the shell 10. The main power supply 46 has its negative terminal connected to the cathode support block 22 and its positive terminal connected to the side wall 18. The electric arc 34 is formed between the cathode 15 and the side wall 18 of the shell 10. The side wall 18 represents the anode and can be connected to ground potential 45 through an electrical lead 49. Alternatively, the anode may be formed from another conductive member (not shown) mounted adjacent to but electrically separate from the side wall. The geometry of such anode would not be critical. In the latter case, the arc conduit can be electrically isolated from the shell 10. It is also obvious that the side wall 18 can be electrically insulated from the other walls of the shell 10 by using insulating separators such as those shown at 23. It is also obvious that the anode side wall 18 can be freefloating with the ground at 45 removed and the shell wall 16, 17 and 19 grounded.

Any conventional arc starting procedure may be used including physically contacting the cathode end surface 35 with a wire electrode 50. The wire electrode 50 is electrically connected to anode side wall 1S or a separate anode (not shown) through a high resistance R. In addition the wire electrode 50 is connected to a plunger assembly 53 through an insulated sleeve 51 in the mounting flange 25. The plunger assembly 53 moves the wire electrode into physical contact with the cathode end surface 35 and then retracts it. A conventional plunger assembly for performing this operation is taught and described in U.S. Pat. No. 4,448,799. However, any mechanism capable of moving the starting wire electrode 50 into contact with the cathode 15 and withdrawing it may be used to practice the present invention. Alternatively, an arc may be started by other conventional methods including transferred arc starting and spark starting using a spark plug.

In touch starting, once contact is made between the staffing wire electrode 50 and the cathode 15, current flows from the main power supply 46 through the cathode 15 and wire electrode 50 to anode side wall 18. Retraction of the wire electrode 50 breaks contact with the cathode 15 to form an electric arc. The high resistance R causes the arc to transfer to the anode side wall 18 which is a less resistive path than the path to the wire electrode 50.

Any gas may be supplied to the cathode chamber 37 and then to vacuum chamber 11 through the narrow space 40 of elongated member 36 depending upon the coating to be formed on the fishing hook 14. The use of an inert gas such as argon is preferred for depositing a coating of elemental or alloy source material corresponding to the cathode material, e.g., Si, Cu, Al, W, Mo, Cr, Ta, Nb, V, Hf, Zr, Ti, Ni, Co, Fe and their alloys including alloying elements Mn, Si, P, Zn, B and C. The inert gas in this instance is not intended to react with the metal vapor in the plasma. Other inert gases that may be used include neon, krypton, xenon and helium. Reactive gases include nitrogen, oxygen, hydrocarbons such as CH.sub.4 and C.sub.2 H.sub.2, carbon dioxide, carbon monoxide, diborene (B.sub.2 H.sub.6), air, silane (SiH.sub.4) and combinations. Nitrogen is used as the preferred reactive gas with metal vapor from metal cathodes including Ti, Zr, Hf, V, Nb, Ta, Cr, Mo, W, Si and Al to form refractory nitride coatings TiN, Ti.sub.2 N, ZrN, HfN, VN, V.sub.3 N, Nb.sub.2 N, NbN, TaN, Ta.sub.2 N, CrN, Cr.sub.2 N, MoN, Mo.sub.2 N, Mo.sub.3 N, WN, W.sub.2 N, Si.sub.3N.sub.4, AIN and their compounds. Nitride-metal composites such as TiN—Ni and ZrN—Ni and complex nitrides such as (Ti,Zr)N, (Ti, AI,V)N and (Ti,V)N can be produced by employing multiple or composite cathodes. Accordingly, carbide, oxide and boride compound coatings can be produced when a reactive gas comprised of carbon, oxygen and boron is used, for example TiC, TiO, TiO.sub.2 and TiB.sub.2. In addition, interstitial nitride-, carbide-, boride- and oxide-compound coatings can also be made by employing more than one reactive gas species, for example, TiCN, TiON and TiOCN. In all cases, the gas should be fed into the cathode chamber 37 and then into the vacuum chamber 11 at rate compatible with the withdrawal rate of the vacuum pumping system to maintain the desired operating pressure of between 10.sup.−1 to 5.times.10.sup.−4 torr.

The plasma produced by the high current density arc includes atoms, molecules, ionized atoms and ionized molecules of the cathode evaporation surface 35 and ionized species of gases. Biasing the fishing hook 14 negatively with respect to the anode or to both the anode and cathode influences the smoothness, uniformity and surface morphology of the coating. The bias power supply should be adjusted to a bias potential to optimize the coating operation. For a TiN, or ZrN, coating a bias potential for power supply 44 of between 50 and 400 volts is acceptable with a bias potential between 100 and 200 volts preferred for TiN and a bias potential between 50 and 250 volts preferred for ZrN.

Gas is fed through the space 40 into the cathode chamber 37 representing the volume of space between the cathode evaporation surface 35 and the open end 41 of the elongated member 36. The gas envelops the high current density arc in the cathode chamber 37 over the distance “x” resulting in an increase of plasma pressure and temperate. The plasma extends from the cathode evaporation surface 35 through the relatively high pressure region in the cathode chamber 37 and exits through the open end 41 of the elongated member 36 towards the relatively lower pressure region in the vacuum chamber 11, or chamber volume 72, where the negatively biased substrate 14 is located. An additional benefit of feeding gas through the narrow space 40 into cathode chamber 37 is that the gas in space 40 serves as an insulator to prevent arcing from the cathode 15 to the member 36.

During operation, some of the evaporated cathode material will deposit on the inside surface of the member 36 to form a deposit 60. This is diagrammatically illustrated in FIG. 2. The gas injected from narrow space 40 prevents the deposit 60 from accumulating and bridging over to the cathode 15. Instead, as the operation proceeds, a convergent nozzle 62 is formed between the deposit 60 and the outer edge 61 of the cathode 15. The outer edge 61 becomes more pronounced as the evaporable end surface 35 is consumed. The gas flows through this convergent nozzle 62 across the face 35 of cathode 15 and into the plasma contained in cathode chamber 37. After prolonged operation, both the evaporable end surface 35 and the outer edge 61 recede enlarging the distance “x”. The enlargement in the distance “x” is less than about 0.35 cm during normal operation and is therefore insignificant to the method of the invention. The deposit 60 apparently continues to accumulate as the edge 61 recedes so as to maintain the dimension “y” of the convergent nozzle 62 substantially constant by shifting its position in conjunction with the eroded outer edge 61. The dimension “y” is maintained substantially constant at a value greater than zero and less than about 0.4 cm over the range of operating parameters. Control over the dimension “y” results from the method of introducing gas into the cathode chamber 37. Accordingly, the operation of the convergent nozzle 62 is a self-correcting phenomenon which assures that the gas continues to be directed across the face 35 of the cathode 15 as it flows into the cathode chamber 37 from narrow space 40. In accordance with the present invention, the gas must always first enter the cathode chamber 37 before the gas enters the vacuum chamber 11, or chamber volume 72.

Another suitable method for producing fishing hooks of the present invention consists in depositing under vacuum, for example by cathodic sputtering, by vacuum evaporation, or by ion projection, titanium in presence of nitrogen at the surface of the fishing hook. During this deposition, the amount of nitrogen introduced into the treatment chamber varies continuously from zero to a value defined by the desired result, in such a manner that the composition of the coating, starting from the bare surface of the hook, varies progressively from pure titanium to titanium nitride having an approximately stoichiometric composition.

According to a particularly advantageous technique, the electric polarization of hook is simultaneously varied, so as to progressively vary the mechanical compression stresses from a minimum value at the start of coating to a maximum value at the end of coating. One obtains in this manner a coating which, starting from the bare surface of hook, has a given gradient of nitrogen concentration and of mechanical stress. The coating obtained thereby has minimum shear stresses at the surface of contact of the article with the coating, as well as the desired optical, mechanical and anticorrosive properties.

The titanium coating, which may have a thickness lying between 0.1 and 20 micron, may be produced by vacuum deposition of at least one of the following metals: titanium, zirconium, hafnium, vanadium, niobium, tantalum, chromium, molybdenum, tungsten, aluminium. This deposition may be effected in presence of one of the following elements: carbon, nitrogen, oxygen, boron, silicon, fluorine, chlorine, sulphur, phosphorus. As with titanium nitride, the proportion of these elements is increased progressively during the phase of vacuum deposition of the previously mentioned metals.

At the same time, as the coating thickness increases, the articles to be treated are polarized more and more negatively. This enables to obtain a coating having an increasing concentration of non metallic elements and having increasing mechanical stress states.

For optimal adherence of the titanium coating, a stainless steel fishing hook will have been previously degreased and dried, is placed in a cathodic sputtering chamber under vacuum. During a first stage, it undergoes ion bombardment with argon ions, so as to eliminate the last superficial traces of contaminant. The hook is next negatively polarized to several tens of volts, and deposition of titanium by cathodic sputtering is begun. As the coating thickness grows, the electric polarization of this article is progressively increased, and an increasing flow of nitrogen is introduced into this chamber, so as to deposit a titanium nitride compound which is increasingly rich in nitrogen. At the end of the titanium nitride deposition, when the coating thickness reaches one micron, the polarization of hook may amount to a value lying between 150 and 250 volts, and the proportion of nitrogen atoms in the titanium nitride will be approximately 50%.

Fishing hooks made in accordance with this invention exhibit superior performance compared to conventional types of hooks. Improvements in such performance criteria as penetrating point and barb point wear and high penetration facility. Such improvements are related to the fact that the invention provides for better edge strength, wear-resistance and coefficient of friction than has been possible previously in the context of fishing hooks.

The composition of the present invention has significant advantages compared to materials used for fishing hook construction previously. For example, the composition can be varied within the scope of this invention to provide superior wear-resistance or to provide a greater degree of toughness, as required. This is particularly advantageous in the critical wear areas of a fishing hook.

The ease of control of the composition permits a high quality fishing hook to be manufactured. The strength and durability of the penetrating surfaces exhibits the desired wear resistance and toughness and represents an unexpected and significant advance in fishing hook construction.

In a fishing hook according to the present invention, the mode of wear is primarily individual particles flattening due to abrasion, not the more destructive oxidation with resultant deformation, as with stainless steel hooks.

While the invention has been disclosed herein in connection with certain embodiments and detailed descriptions, it will be clear to one skilled in the art that modifications or variations of such details can be made without deviating from the gist of this invention, and such modifications or variations are considered to be within the scope of the claims hereinbelow.

It should be noted that no claim is made to the processes or method of plating or coating articles in general, as shown above, but rather to the end product of a fishing hook made of, or coated (wholly or partially) with titanium an alloy of titanium, or such method(s) as produce such specific end-products.

What is claimed is:

1. A process for depositing titanium or titanium alloy onto a fishing hook comprising the steps of:
placing a fishing hook within a vacuum chamber, said vacuum chamber having a cathode where said cathode has an evaporation surface material, said vacuum chamber further being in combination with a bias power supply;
positioning said fishing hook within said vacuum chamber;
supplying a gas within said vacuum chamber such that said gas surrounds said fishing hook;
starting an electrical arc within said vacuum chamber thereby producing a plasma, comprising ionized particles of said gas and ionized particles of said cathode evaporation surface material; and
adjusting said bias power supply to a bias potential to optimize coating of said fishing hook.
